(19) United States
(12) Patent Application Publication
(10) Pub. No.: US 2013/0035615 A1
(43) Pub. Date: Feb. 7, 2013

(54) INSTANT-SUCTION PRESSURE-ADJUSTABLE CUPPING DEVICE AND CUPPING THERAPY METHOD USING THE SAME

(71) Applicant: Lisa Li-Chen HSIEH, Kaohsiung City (TW)

(72) Inventor: Lisa Li-Chen HSIEH, Kaohsiung City (TW)

(21) Appl. No.: 13/196,205

(22) Filed: Aug. 2, 2011

(51) Int. Cl. A61H 7/00

(52) U.S. Cl. 601/6

(57) ABSTRACT

The present invention discloses an instant-suction pressure-adjustable cupping device and a cupping therapy method using the same. The method of the present invention comprises steps: respectively measuring cupping pressure-drop values of various regions of healthy persons and patients as normal pressure-drop values and reference pressure-drop values, and storing the data in a database; retrieving from the database one reference pressure-drop value corresponding to a cupped region of a patient; performing a weighted calculation on the reference pressure-drop value to obtain a pressure-drop value for the patient according to regulation factors, including the personal elementary conditions, symptom and cupped region; placing a cupping vessel of the instant-suction pressure-adjustable cupping device on the region to be cupped, exhausting air inside the cupping vessel with an air pump until the pressure-drop value is attained, and keeping the cupping vessel staying on the body of the patient to perform a cupping therapy.

### BACKGROUND OF THE INVENTION

1. Field of the Invention

The present invention relates to a therapeutic technology, particularly to an instant-suction pressure-adjustable cupping device and a method for calculating cupping pressure.

2. Description of the Related Art

Cupping therapy is a primary or complementary therapeutic means in traditional Chinese medicine. The current cupping methods include the fire cupping method and the suction cupping method. In the fire cupping method, fire is used to increase the temperature of the interior of a cupping vessel. Once fire is ceased, the internal temperature of the cupping vessel decreases in an airtight state, and the pressure inside the cupping vessel decreases to lower than the atmospheric pressure. Thereby is generated suction force. However, inexperienced personnel are likely to cause burn injuries on patients when using the fire cupping method. In the conventional suction cupping method, a manual or mechanical device is used to suck the air inside a cupping vessel. However, only the patient himself knows what extend of suction his skin can tolerate. Therefore, the cupping pressure is hard to control to an optimal state except the patient operates the suction device by himself.

Sometimes, a person seems sturdy but has some hidden diseases in fact. If such a person is cupped by a normal suction force, he may feel uncomfortable. For example, when a healthy aged person is cupped according to the standard for the young, his muscular tissue may be wounded by too intense a sucking force. Even worse, he may feel dizzy or lose consciousness because of poor blood circulation. Besides, the rim of the existing cupping vessel can only apply to flat regions. The conventional cupping technology can only either abandon cupping non-flat regions or adopt a cupping vessel having a smaller-diameter rim for non-flat regions. However, a smaller cupping vessel increases the pressure per unit area and may harm the cupped region.

Accordingly, the present invention proposes an instant-suction pressure-adjustable cupping device and a cupping therapy method using the same to overcome the abovementioned problems, wherein the strength of the sucking force and the duration of cupping are precisely controlled, and wherein an elastic packing ring is attached to the rim of the cupping vessel to make the vessel rim tightly attached to the non-flat regions of the human body. The principles and embodiments of the present invention will be described in detail below.

### SUMMARY OF THE INVENTION

The primary objective of the present invention is to provide a cupping therapy method, which performs a weighted calculation on a preset reference pressure-drop value according to the elementary conditions of the patient, the symptom to be treated, the acupoints on the concerned region, etc., to obtain a specified pressure-drop value of cupping, whereby patients of different conditions can respectively get appropriate therapies.

Another objective of the present invention is to provide a cupping therapy method, which provides different weighted values for ages, genders, physical states, mental states, diseases, seriousness of diseases, cupped regions, flatness of cupped regions, tissue robustness of cupped regions, size of cupped regions, and acupoints on cupped regions, whereby the therapy is adapted to the physical conditions of the patient.

Yet another objective of the present invention is to provide a cupping therapy method, wherein two sets of pressure-drop values are respectively obtained from the cupped regions of healthy persons and patients to function as references for calculation.

Still another objective of the present invention is to provide an instant-suction pressure-adjustable cupping device, which provides different sucking forces for different cupped regions of the human body, and which can precisely control the duration of cupping.

Yet still another objective of the present invention is to provide an instant-suction pressure-adjustable cupping device, which comprises several vacuum tanks, wherein a first electromagnetic valve and a second electromagnetic valve are respectively arranged at two sides of each vacuum tank, and wherein a vacuum pump and the first electromagnetic valve adjacent to the vacuum pump are switched on until the vacuum tank is evacuated to a preset pressure, whereafter the second electromagnetic valve adjacent to a cupping vessel is switched on, whereby the cupping vessel has sucking force to perform a cupping therapy.

A further objective of the present invention is to provide an instant-suction pressure-adjustable cupping device, wherein the cupping vessel is equipped with a pressure meter whereby the user can control the duration of cupping, and wherein the rim of the cupping vessel is equipped with an elastic packing ring whereby the rim of the cupping vessel is tightly attached to the cupped region.

To achieve the abovementioned objectives, the present invention proposes a cupping therapy method, which comprises steps: measuring the cupping pressure-drop values of various regions of healthy persons as the normal pressure-drop values, and measuring the cupping pressure-drop values of various regions of patients as the reference pressure-drop values, and storing the information in a database; when a cupping therapy is intended to performed on a patient, retrieving a corresponding reference pressure-drop value from the database according to the region to be cupped; performing a weighted calculation on the reference pressure-drop value to obtain a pressure-drop value of cupping according to regulation factors, including elementary conditions of the patient, the symptoms to be treated, and the region to be cupped; placing a cupping vessel on the region to be cupped, and exhausting the air inside the cupping vessel with an air pump until the pressure-drop value is attained, and keeping the cupping vessel staying on the body of the patient to perform a cupping therapy.

The present invention also proposes an instant-suction pressure-adjustable cupping device, which comprises a plurality of vacuum tanks, a vacuum pump, a plurality of sets of electromagnetic valves and at least one cupping vessel, wherein the vacuum pump connects with the vacuum tanks via a plurality of first hoses and evacuates the vacuum tanks to a negative pressure, and wherein the cupping vessel connects with the vacuum tanks via at least one second hose. The cupping vessel contacts the skin of the user. When the air inside the cupping vessel is evacuated to a negative pressure, the cupping vessel is tightly attached to the skin of the user, and the cupping therapy starts. The electromagnetic valves are arranged along the hoses. Each set of electromagnetic valves includes a first electromagnetic valve and a second electromagnetic valve respectively arranged on two sides of the vacuum tank. The vacuum pump and the first electromagnetic valve are switched on to control the pressure inside the vacuum tank. A first pressure meter is used to indicate whether the pressure inside the vacuum tank has reached the preset value. Second pressure meters are used to indicate whether the pressures inside the cupping vessels have decreased to a range for removing the cupping vessels. Besides, an elastic packing ring is arranged on the rim of the cupping vessel to enable the cupping vessel to airtightly adhere to various regions of the user, which have different contours and different flatnesses.

Below, the embodiments are described in detail to make easily understood the objectives, technical contents, characteristics and accomplishments of the present invention.

### BRIEF DESCRIPTION OF THE DRAWINGS

FIG. 1 schematically shows an instant-suction pressure-adjustable cupping device according to one embodiment of the present invention;

FIG. 2 schematically shows the detailed structure of an instant-suction pressure-adjustable cupping device according to one embodiment of the present invention;

FIGS. 3A-3C are respectively a side sectional view, a top view and a bottom view of an elastic packing ring of a cupping vessel according to one embodiment of the present invention; and

FIG. 4 is a flowchart of a cupping therapy method according to one embodiment of the present invention.

### DETAILED DESCRIPTION OF THE INVENTION

The present invention proposes an instant-suction pressure-adjustable cupping device and a cupping therapy method using the same, wherein the region, area, and suction force of cupping are varied according to the symptom and elementary conditions of the patient lest too great a pressure drop of cupping hurt the patient.

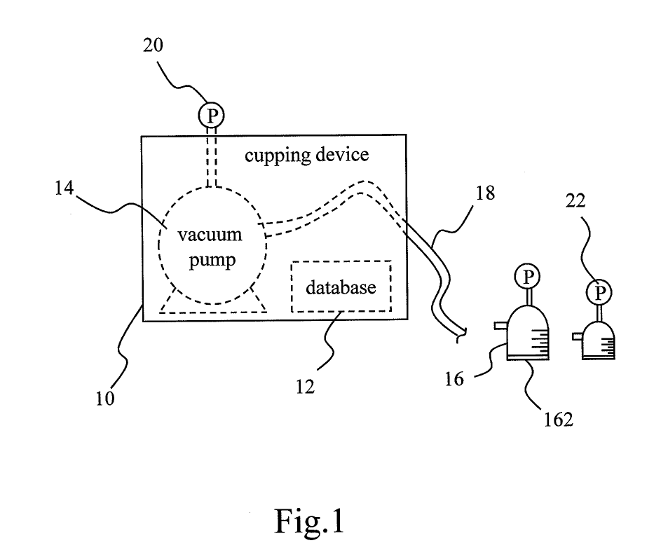

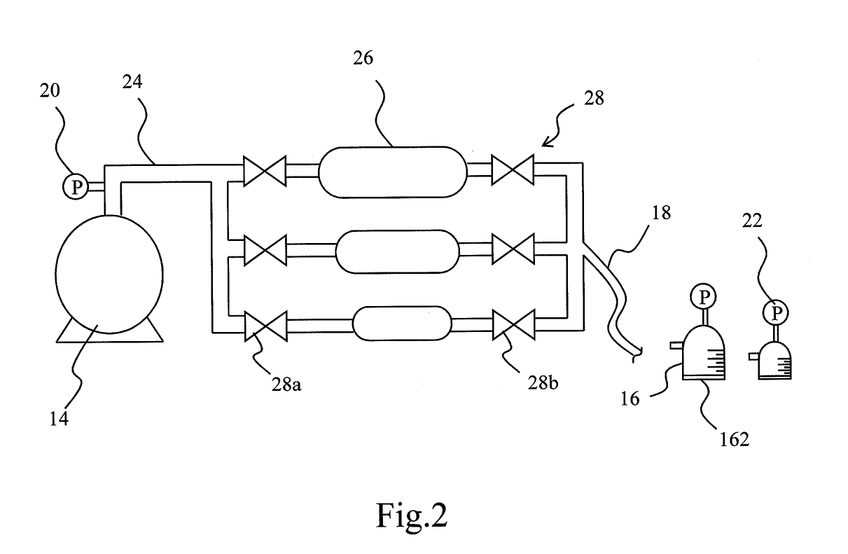

Refer to FIG. 1 a diagram schematically showing an instant-suction pressure-adjustable cupping device according to one embodiment of the present invention. The instant-suction pressure-adjustable cupping device 10 of the present invention comprises a database 12, a vacuum pump 14, at least one cupping vessel 16 and at least one hose 18. The database 12 stores the normal pressure-drop values measured in cupping various regions of healthy persons and the reference pressure-drop values measured in cupping the nidus regions of patients. When started, the instant-suction pressure-adjustable cupping device 10 will read corresponding data from the database 12. Refer to FIG. 2 for detailed structure of the instant-suction pressure-adjustable cupping device 10. The instant-suction pressure-adjustable cupping device 10 further comprises a plurality of vacuum tanks 26, a plurality of sets of electromagnetic valves 28 and a plurality of pressure meters. The vacuum pump 14 connects with the vacuum tanks 26 via hoses 24 and evacuates the vacuum tanks 26 to a negative pressure. The vacuum tanks 26 connect with the cupping vessels 16 via the hoses 18. Each set of the electromagnetic valves 28 has a first electromagnetic valve 28a and a second electromagnetic valve 28b respectively arranged at two sides of the vacuum tank 26 along the hoses, wherein the first electromagnetic valve 28a is arranged in the hose 24 between the vacuum tank 26 and the vacuum pump 14, and wherein the second electromagnetic valve 28b is arranged in the hose 18 between the vacuum tank 26 and the cupping vessel 16. The vacuum pump 14 and the electromagnetic valves 28 can control the pressure of the vacuum tanks 26. The user can provide an appropriate suction force for the cupping vessel 16 via modifying the pressure of the vacuum tanks 26.

The cupping vessels 16 may include several different size cupping vessels respectively having different base areas and applied to different regions. For example, the cupping vessel having a greater base area can apply to cupping the back; the cupping vessel having a smaller base area can apply to cupping the arm. An elastic packing ring 162 is arranged on the rim of the cupping vessel 16 to increase the airtightness between the cupping vessel 16 and the skin of the user. The elastic packing ring 162 is made of a flexible airtight material, such as silicone rubber, Teflon, rubber, or plastic.

A first pressure meter 20 is arranged at the joint of the vacuum pump 14 and the hose 24 to show the pressure of the vacuum pump 14 and the vacuum tank 26. Second pressure meters 22 are respectively arranged on the cupping vessels 16 to indicate the pressures thereof.

When an operator intends to use the instant-suction pressure-adjustable cupping device of the present invention to cup a user, he has to determine the region to be cupped, the size of the cupping vessel and the suction force (the pressure-drop value after pumping air) firstly. Next, the operator switches on the vacuum pump 14 and the first electromagnetic valves 28a to make the vacuum tanks 26 have a specified negative pressure. The specified negative pressure is a preset pressure. The first pressure meter 20 shows the pressure of the vacuum pump 14 and the vacuum tanks 26. When the vacuum tanks 26 are pumped to the specified negative pressure, the operator switches off the vacuum pump 14 and the electromagnetic valves 28a. Next, the operator connects the hose 18 with an appropriate cupping vessel 16 and places the cupping vessel 16 on the concerned region. Next, the operator switches one or more electromagnetic valves 28b, whereby the air inside the cupping vessel 16 is sucked to the vacuum tanks 26. The cupping vessel 16 starts to cup the concerned region of the user the moment the second electromagnetic valves 28b are switched on. When the second pressure meter 22 indicates that the pressure of the cupping vessel 16 has decreased to an appropriate value, the operator lifts up the cupping vessel 16. The operator can effectively control the timing of starting and finishing cupping via the pressure meters 22. The operator can use the pressure meters 20 and the electromagnetic valves 28 to control the negative pressure and undertake a safe cupping therapy. The sucking force is neither too great to safely cup the user nor too small to effectively cup the user. According to the second pressure meter 22, the operator can finish cupping at an appropriate timing.

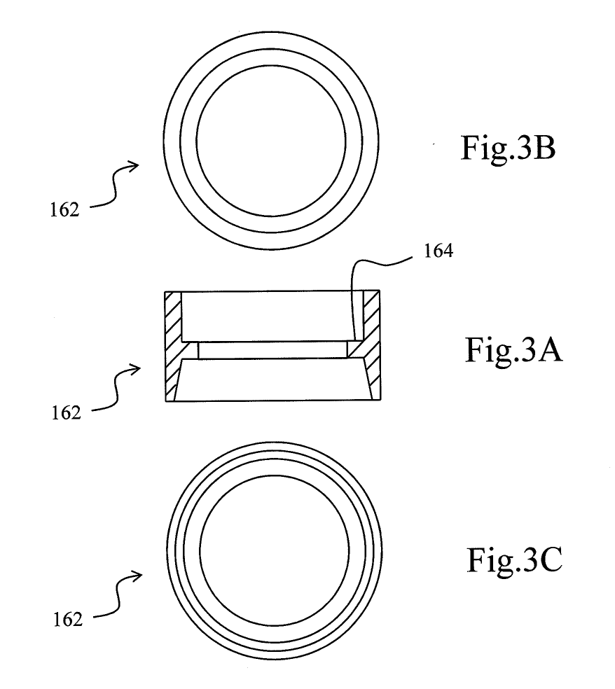

Refer to FIGS. 3A-3C respectively a side sectional view, a top view and a bottom view of an elastic packing ring of a cupping vessel according to one embodiment of the present invention. Two rims of the elastic packing ring 162 respectively have different thicknesses. The thicker rim surrounds the cupping vessel, and the thinner rim contacts the skin of the user. The middle portion of the elastic packing ring 162 protrudes toward the center of the cupping vessel to form a stopper member 164 blocking the cupping vessel.

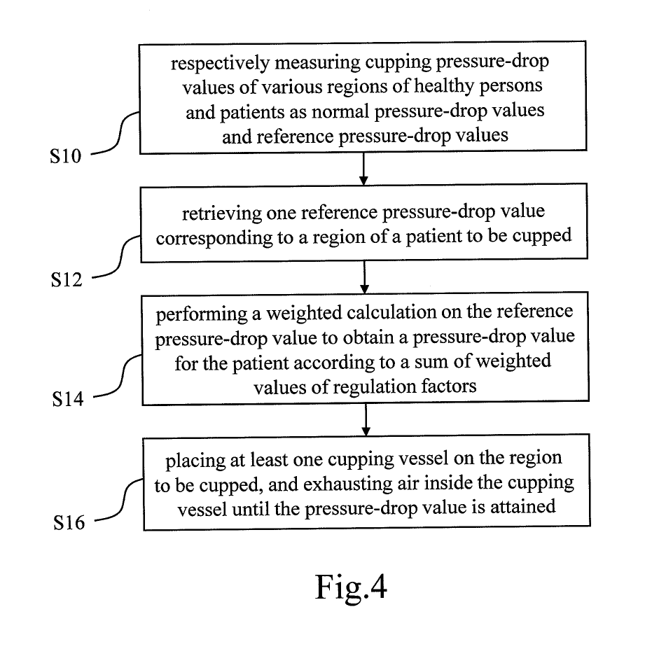

Refer to FIG. 4 a flowchart of a cupping therapy method using the instant-suction pressure-adjustable cupping device shown in FIG. 1 and FIG. 2. In Step S10, measure the cupping pressure-drop values of various regions, such as heads, necks, backs and limbs, of healthy persons as the normal pressure-drop values, and measure the cupping pressure-drop values of various regions of patients as the reference pressure-drop values, and store the information in a database. In Step S12, when a cupping therapy is to be performed on a patient, retrieve a corresponding reference pressure-drop value from the database according to the region to be cupped. In Step S14, perform a weighted calculation on the reference pressure-drop value to obtain a pressure-drop value of cupping according to regulation factors, including elementary conditions of the patient, the symptoms to be treated, and the region to be cupped. In Step S16, place a cupping vessel on the region to be cupped, exhaust the air inside the cupping vessel with an air pump until the pressure inside the cupping vessel realizes the pressure-drop value of cupping, and keep the cupping vessel staying on the body of the patient to perform a cupping therapy.

The pressure-drop value is equal to the atmospheric pressure (760 mmHg) minus the pressure inside the cupping vessel, and ranges from 200 to 620 mmHg. If the pressure-drop value is lower than 200 mmHg, cupping is ineffective and unnecessary.

Hereinbefore, it has been mentioned that the regulation factors include the personal elementary conditions, the symptom to be treated, and the region to be cupped. Herein, the acupoints on the region to be treated are also added to the regulation factors. The personal elementary conditions include the age, gender, physiological state and psychiatric state of a person. The weighted values of a symptom are respectively assigned according to the type, seriousness, and the cupped region of the symptom. The weighted values of a region to be cupped are respectively assigned according to the flatness, tissue robustness and size of the region to be cupped. The weighted values of acupoints are respectively assigned according to whether the cupped region has an acupoint and whether the acupoint is hit. The weighted values of different regulation factors are respectively distributed in different ranges. Table. 1 shows the examples of the weighted values of the personal elementary conditions.

TABLE 1

| | | |
|---|---|---|
| Weighted value of age | Age > 65 | −10% |
| | 25 < age < 65 | 0 |
| | 18 < age < 25 | −5% |
| | 6 < age < 18 | −10% |
| Weighted value of | Male | 0 |
| Gender | Female | −5% |
| Weighted value of | Normal | 0 |
| physiological/psychiatric | Weak | −5% |
| state | Very weak | −10% |

Table. 2 shows the examples of the weighted values of the symptoms to be treated.

TABLE 2

| | | |
|---|---|---|
| Weighted value of symptom | Muscular and skeletal | 0 |
| type | systems | |
| | Nervous system | −5% |
| | Viscera | −10% |
| Weighted value of symptom | Slight | −5% |
| seriousness | Serious | 0 |
| | Very serious | +5% |
| Weighted value of cupped | Back and limbs | 0 |
| region | Abdomen | −5% |
| | Chest and neck | −10% |

Table. 3 shows the examples of the weighted values of the regions to be cupped.

TABLE 3

| | | |
|---|---|---|
| Weighted value of | Flat skin | 0 |
| flatness | Non-flat skin | +5% |
| Weighted value of tissue | Normal | 0 |
| robustness | Robust | +5% |
| | Atrophying/erodent | −10% |
| Weighted value of size of | Diameter > 6 cm | 0 |
| cupped region | 2 cm < Diameter < 6 cm | −5% |
| | Diameter < 2 cm | −10% |

Table. 4 shows the examples of the weighted values of acupoints.

TABLE 4

| | | |
|---|---|---|
| Weighted value of | No acupoint | +5% |
| whether the cupped | Having an acupoint | 0 |
| region has an acupoint | Having an important | −5% |
| | acupoint | |
| Weighted value of | Acupoint hitting | 0 |
| whether the acupoint | undertaken | |
| is hit | Acupoint hitting not | +5% |
| | undertaken | |

Below is introduced an example of calculating the pressure-drop value according to the flowchart in FIG. 4 and the weighted values in Tables. 1-4 .

Suppose that the patient is a slightly senescent woman aged 70 and suffering from serious sciatica. The patient has the following personal elementary conditions: age>65, female, and weak, and the weighted values of the personal elementary conditions sum to −20% (=−10%−5%−5%). The “symptom to be treated” of the patient has the following characteristics: nervous system, serious, back and limbs, and the weighted values of the “symptom to be treated” sum to −5% (=−5%+0%+0%). The “region to be cupped” of the patient have the following characteristics: flat, atrophying/erodent, and diameter>6 cm; the weighted values of the “region to be cupped” sum to −10% (=0%−10%+0%). The “region to be cupped” of the patient has an acupoint, and the acupoint is to be hit; the weighted values of acupoints sum to 0% (=0%+0%). All the weighted values sum to −35% (−20%−5%−10%+0%). The reference pressure-drop value is preset to be 544 mmHg. The pressure-drop value for the patient is calculated as follows:

$$The pressure \text{-} drop value for the patient = the reference pressure \text{-} drop value \times ( 100 \% + the sum of the weighted values of all the regulation factors ) . = 544 mm \text{-} Hg \times ( 100 \% - 35 \% ) = 353.6 mm \text{-} Hg \approx 350 - 360 mm \text{-} Hg$$

The reference pressure-drop value 544 mmHg is too high for the abovementioned patient. If the patient is cupped with the reference pressure-drop value, her atrophying skin may be further hurt by the sucking force. Besides, she may feel faint or even lose consciousness in such a status. Therefore, the method of the present invention modifies the reference pressure-drop value according to various conditions of a patient to obtain a pressure-drop value suitable for the patient.

In conclusion, the present invention proposes a cupping therapy method, which comprises steps: storing the reference pressure-drop values, which are obtained from experiments, in a database; retrieving a reference pressure-drop value corresponding to a cupped region from the database when a cupping therapy is intended to perform on a patient; and performing weighting calculations to obtain a pressure-drop value more suitable for the patient according to various conditions of the patient. The method of the present invention can precisely control the sucking force of cupping lest too strong a sucking force hurt the patient or an insufficient sucking force fail to implement an effective cupping therapy.

The embodiments described above are only to exemplify the present invention but not to limit the scope of the present invention. Any equivalent modification or variation according to the spirit of the present invention is to be also included within the scope of the present invention.

What is claimed is;

1. A cupping therapy method comprising steps:
measuring cupping pressure-drop values of various regions of healthy persons as normal pressure-drop values, and measuring cupping pressure-drop values of various regions of patients as reference pressure-drop values, and storing said normal pressure-drop values and said reference pressure-drop values in a database of a cupping device;
retrieving from said database one said reference pressure-drop value corresponding to a region of a patient to be cupped;
performing a weighted calculation on said reference pressure-drop value to obtain a pressure-drop value for said patient according to a plurality of regulation factors, including personal elementary conditions of said patient, symptoms of said patient to be treated, and a region of said patient to be cupped;
placing at least one cupping vessel on said region to be cupped, and exhausting air inside said cupping vessel with an air pump until said pressure-drop value is attained.

2. The cupping therapy method according to claim 1, wherein said regions include chests, necks, abdomens, and limbs, and wherein said personal elementary conditions include age, gender, and physiological/psychiatric states.

3. The cupping therapy method according to claim 1, wherein weighting said symptoms of said patient to be treated involves weighting types of symptoms, seriousness of symptoms, and regions to be cupped.

4. The cupping therapy method according to claim 1, wherein weighting said region of said patient to be cupped involves weighting flatness of skin, robustness of tissue, and size of said region.

5. The cupping therapy method according to claim 1, wherein said regulation factors include whether said region to be cupped has an acupoint, and whether said acupoint is to be hit.

6. The cupping therapy method according to claim 1, wherein said pressure-drop value ranges from 200 to 620 mmHg.

7. The cupping therapy method according to claim 1, wherein said pressure-drop value is obtained via obtaining a sum of a plurality of weighted values of said regulation factors and using said sum to perform a weighted calculation on said reference pressure-drop value.

8. The cupping therapy method according to claim 1, wherein cupping vessels having different sizes of openings are respectively applied to different sizes of said regions to be cupped.

9. The cupping therapy method according to claim 1, wherein said air pump is equipped with at least one pressure meter indicating pressure inside said cupping vessel.

10. The cupping therapy method according to claim 1, wherein said cupping device includes said cupping vessel and said air pump.

11. An instant-suction pressure-adjustable cupping device comprising
a plurality of vacuum tanks;
a vacuum pump connecting with said vacuum tanks via a plurality of first hoses and exhausting said vacuum tanks to have a negative pressure;
at least one cupping vessel connecting with said vacuum tanks via at least one second hose; and
a plurality of sets of electromagnetic valves arranged on said hoses, wherein each set of said electromagnetic valves has two electromagnetic valves respectively arranged on two sides of said vacuum tank, and wherein said vacuum pump and said electromagnetic valves are switched on or off to control pressure inside said vacuum tanks.

12. The instant-suction pressure-adjustable cupping device according to claim 11 further comprising a first pressure meter arranged at a joint of said vacuum pump and said first hoses and used to show a pressure value of said vacuum pump, wherein said vacuum pump and said electromagnetic valves are switched on/off manually or by an adjustable pressure switch automatically.

13. The instant-suction pressure-adjustable cupping device according to claim 11 further comprising second pressure meters respectively arranged on said cupping vessels and showing pressures inside said cupping vessels.

14. The instant-suction pressure-adjustable cupping device according to claim 11, wherein said vacuum tanks have an identical size or respectively have different sizes.

15. The instant-suction pressure-adjustable cupping device according to claim 11, wherein an elastic packing ring is arranged on a bottom of said cupping vessel and increases airtightness between said cupping vessel and skin of a user.

16. The instant-suction pressure-adjustable cupping device according to claim 11, wherein said cupping vessels respectively have different sizes and base areas.

17. The instant-suction pressure-adjustable cupping device according to claim 11, wherein each set of said electromagnetic valves includes a first electromagnetic valve and a second electromagnetic valve, and wherein said first electromagnetic valve is arranged between said vacuum pump and said vacuum tank, and wherein said second electromagnetic valve is arranged between said vacuum tank and said cupping vessel.

18. The instant-suction pressure-adjustable cupping device according to claim 17, wherein said vacuum pump and said first electromagnetic valve are switched on to evacuate said vacuum tank.

19. The instant-suction pressure-adjustable cupping device according to claim 17, wherein said cupping vessel is placed on a region to be cupped, and wherein said second electromagnetic valve is switched on to exhaust air inside said cupping vessel.

20. The instant-suction pressure-adjustable cupping device according to claim 15, wherein said elastic packing ring is made of a flexible airtight material that is selected from a group consisting of silicone rubber, Teflon, rubber and plastic.
